(19) United States
(12) Patent Application Publication
(10) Pub. No.: US 2011/0258163 A1
(43) Pub. Date: Oct. 20, 2011

(54) DYNAMICALLY CREATED TWO-STAGE SELF EXTRACTING ARCHIVES

(75) Inventors: Serge Volkoff, San Bruno, CA (US); Darryl Lovato, Royal Oaks, CA (US); Michael Halpin, Soquel, CA (US)

(73) Assignee: SMITH MICRO SOFTWARE, INC., Aliso Viejo, CA (US)

(21) Appl. No.: 13/091,080

(22) Filed: Apr. 20, 2011

Related U.S. Application Data
(60) Provisional application No. 61/326,132, filed on Apr. 20, 2010.

(51) Int. Cl. G06F 17/30

(52) U.S. Cl. 707/661; 707/E17.01

(57) ABSTRACT

A method of dynamically creating a two-stage self-extracting archives. During the archive creation process the executable code segments for inverse algorithms are selectively added to the self-extracting archive, but only for those algorithms applied during archive creation. This results in a considerably smaller size of the self-extracting archive. Additional space savings can be achieved by reprocessing the original data to eliminate the use of any algorithm applied in the archive creation which resulted in less savings than the additional size of the corresponding inverse algorithm. The selected inverse algorithms are themselves compressed. A compact inverse algorithm is provided as ready-to-execute code, which restores the selected inverse algorithms to an executable state, and then causes them to be executed on the compressed file data.

### CROSS REFERENCES TO RELATED APPLICATIONS

The present application claims the benefit of U.S. Provisional Patent Application Ser. No. 61/326,132 filed Apr. 20, 2010 (Apr. 20, 2010).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### SEQUENCE LISTING

Not applicable.

### BACKGROUND OF THE INVENTION

Field of the Invention: The present invention relates generally to data compression and archiving. More particularly the present invention relates to a system and method for dynamically creating two-stage self-extracting archives. More specifically, the method relates to intelligent selective linking of the decompressor/decryptor in the code segment of a self-extracting archive to reduce the overall size of the overall file.

Definitions: As used herein, the following terms shall generally have the indicated meanings:

Archive: a collection of files created for the purpose of storage or transmission, usually in compressed and otherwise transformed form. An archive generally includes structural information and archive data.

Self-Extracting Archive: a compressed archive file containing a compressed file archive as well as associated programming to extract this information. While typical archive files require a second executable file or program to extract from the archive, self-extracting archives generally do not require such a program or executable file.

Algorithm: a specific computational technique used for processing information.

Compression Algorithm: a specific computational technique used for encoding information using fewer bits than an encoded representation would use through use of specific encoding schemes

File: a set of one or more typed forks, also possessing optional attributes, which may include, but are not limited to directory, name, extension, type, creator, creation time, modification time, and access time.

Archive Data: file data in transformed form.

Archive Creation: the process of combining one or more files and their attributes into an archive.

Full Archive Expansion: the process of recreating forks, files, and their attributes from an archive.

Inverse Algorithm: transformation of data that is the inverse of another algorithm.

Background Discussion: Current archiving software such as STUFFIT®, ZIP®, RAR® and similar products create a self-extracting archive by statistically linking the code segment of the self-extracting archive. When creating a self-extracting archive, archiving software currently in use must add every possible algorithm (as well as supporting data necessary to extract files; e.g., tables or dictionaries) to the code segment. This may (and typically does) result in the creation of an unnecessarily large self-extracting archive.

When a self-extracting archive is created, not all of the algorithms need to be added to the self-extracting archive because only a subset of the possible algorithms is necessary for expansion of the archive. However, using the currently available archiving software, such as the utilities mentioned above, all algorithms are linked to the archive at the time of archive creation, whether or not these algorithms are utilized during the decompression process. Some of the algorithm code is therefore superfluous. The addition of such superfluous algorithm code to the archive results in a needlessly large archive size, sometimes even larger than the original uncompressed data.

In the existing approach, a fixed subset of the available algorithms is supported in order to limit the size of the code segment of a self-extracting archive and compression choices are limited to that fixed subset. This traditional approach may lead to any or all of the following potential problems: (1) algorithm code that will not be executed during expansion may nonetheless be included; (2) algorithms that might produce a smaller archive may be excluded; (3) an algorithm that is both included and used, may nonetheless result in smaller savings in the archived data than what it adds in code size.

It would therefore be desirable to provide a method of dynamically selecting the algorithms to be applied when the archive is created, and limiting the executable code included in the self-extracting archive to include only the corresponding inverse algorithms so as to facilitate a considerable reduction in the size of the resulting self-extracting archive.

### SUMMARY OF THE INVENTION

The needed solution to the above-described problem is provided by the present invention, which is a method of dynamically creating a two-stage self-extracting archives. The method is implemented on a data processing computer, wherein during the archive creation process the executable code segments for inverse algorithms are selectively added to the self-extracting archive, but only for algorithms applied during archive creation. This archive creation process results in a considerably smaller size for the self-extracting archive. To achieve even further space saving, the original data can be reprocessed and any algorithm applied in the archive creation process that resulted in less space saving than the additional size of the corresponding inverse algorithm can be eliminated. Selected inverse algorithms are also compressed, and a compact inverse algorithm is provided as ready-to-execute code. This compact inverse algorithm restores the selected inverse algorithms to an executable state, and then causes them to be executed on the compressed file data.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic flow diagram showing an embodiment of the steps employed by the inventive method for dynamically creating two-stage self-extracting archives;

FIG. 2 is a schematic detailed view of an embodiment of the self-extracting archive created by the process shown in FIG. 1; and

FIG. 3 is a schematic flow diagram showing the steps in a preferred embodiment of the inventive method for extracting and decompressing/decrypting the self-extracting archive.

### DETAILED DESCRIPTION OF THE INVENTION

The invention will be understood and its various objects and advantages will become apparent when consideration is given to the following detailed description thereof. Such description makes reference to the annexed drawings.

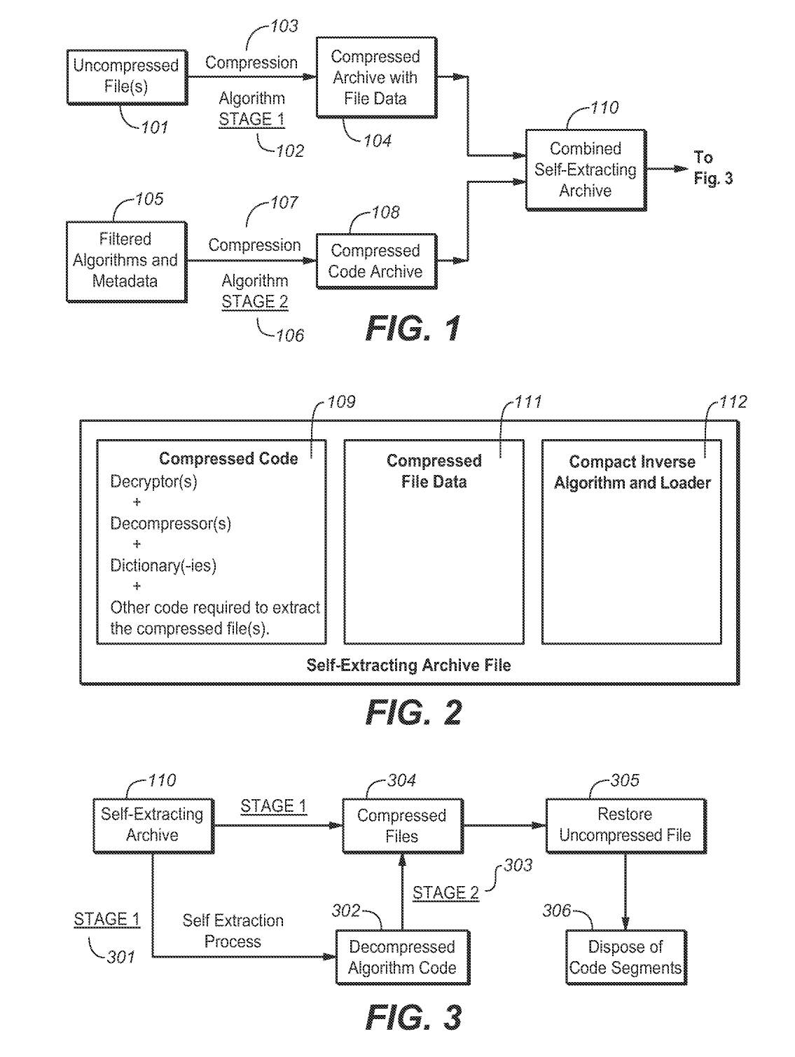

Referring first to FIG. 1, there is shown an embodiment of the steps of the inventive method for dynamically creating a two-stage self-extracting archive, which is implemented on a data processing computer using a program encoded on a computer-readable medium. When creating a self-extracting archive, depending on the type of uncompressed input file 101 present, in the first stage of the archiving process 102, a suitable type of compressor is run, and a compressed archive is prepared 104.

At this first stage all of the code modules used to prepare the archive are filtered separately 105. Furthermore, the savings in storage is increased by separately calculating the savings achieved by using each algorithm. For example, if the text optimizer comprises 100 kB of code and its dictionary comprises 100 kB, and using the optimizer does not produce at least 200 kB of savings in the archive, then no overall savings was achieved and the files are re-coded without the text optimizer, and the text optimizer code is removed from the subset of algorithms. This technique of re-coding the original archive leads to efficient storage in the self-extracting archive.

In the second stage of the archiving process 106, to further the savings in storage, a secondary archive structure of the code part of the self-extracting archive is prepared with another compact compressor 107. The code archive 108 includes the algorithm code module 109, the main code for parsing and extracting the archive in a compressed format (such as STUFFIT®, ZIP® or RAR®), the user interface code, and so forth—all of the code segments are compressed. This facilitates the further reduction in size of the self-extracting archive 110, which also includes the file data 111 and code for the compact inverse algorithm 112 used to load and decompress necessary algorithms. The self-extracting archive may be saved on any of a number of suitable data storage media, such as ROM, flash memory, hard disks, floppy discs, magnetic tapes, optical discs, and so forth, using any of a number of suitable storage devices, including hard disc drives, tape disc drives, compact disc drives, digital video disc drives, Blu-ray disc drives, flash memory data storage devices, and the like. [STUFFIT® is a registered trademark of Smith Micro Computer, Inc., of Aliso Viejo, Calif.; ZIP® is a registered trademark of Iomega Corporation, San Diego, Calif.; RAR® is a registered trademark of Eugene Roshal of Chelyabinsk, Russian Federation.]

Referring next to FIG. 3, the self-extraction process 300 also comprises two stages. In the extraction process first stage 301, the compact inverse algorithm extracts the code module segments, and runs the algorithms 302 (e.g., decompressor(s) and decryptor(s)).

At the second stage 303 the compressed files are extracted from the concatenated archive 304 and the original files are restored 305, and upon completion, the code segments that were temporarily extracted and run on the user's machine are disposed of 306.

It will be appreciated by those with skill in the art that the above-described method reduces the size of self-extracting archives by dynamically creating two-stage self-extracting archives which selectively include an appropriate/optimal decompressor/decryptor in the code segment of the archive. This advances the art of reducing demands on expensive hardware resources, such as disk storage space, and data communications resources, such as transmission bandwidth. The algorithms involved in the method steps are encoded and stored as a program on a computer-readable medium. Thus, the method is implemented on a programmable device, such as a suitable encoder/decoder, which executes the instructions for dynamically creating a two-stage self-extracting archive.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method of dynamically creating a two-stage self-extracting archives implemented by a data processing computer, comprising the steps of:
(a) receiving an input data file;
(b) using algorithms to compress, encrypt and process the data file;
(c) selectively adding the executable code for inverse algorithms to the self-extracting archive during the archive creation process, but only for those algorithms selected applied during archive creation.

2. The method of claim 1, further including the step of:
(d) eliminating any executable code for any algorithm applied in the archive creation that provides less savings than the additional size of the corresponding inverse algorithm;
(e) compressing any selected inverse algorithm code;
(f) providing ready-to-execute code for the inverse algorithm for restoring the selected inverse algorithm to an executable state; and
(g) executing the restored inverse algorithms on the compressed archive data.

3. A method of dynamically creating a two-stage self-extracting archive using a program encoded on a computer-readable medium, said method comprising the steps of:
(a) receiving an uncompressed input data file;
(b) selecting suitable algorithms for the input data file;
(c) running the algorithms and preparing a compressed archive;
(d) separately filtering all of the elements comprising the code module used to prepare the compressed archive,
(e) calculating the savings in storage to determine whether any of the elements of the code module do not produce savings greater than the space required to store that particular code segment element in the compressed archive;
(f) if on performing step (e) one of the elements of the code module does not produce savings greater than the space required to store that code segment, then recoding the files without that algorithm and removing its code segment;
(g) using algorithms to compress the code module elements of the self-extracting archive; and
(h) preparing and storing a self-extracting archive on a suitable data storage medium using a suitable data storage device.

4. The method of claim 3, wherein the code segment includes a decryptor, a decompressor, a dictionary, and other code files required to extract compressed files from the compressed archive.

5. A self-extraction process implemented on a data processing computer using a program encoded on a computer-readable medium, comprising the steps of:
(a) receiving a self-extracting archive;
(b) extracting the code module elements;
(c) running the code module elements;
(d) extracting the compressed files from the self-extracting archive; and
(e) restoring the original files.

6. The method of claim 5, further including the step of:
(f) disposing of the code module elements that were temporarily extracted and run;

7. A method of dynamically creating a two-stage self-extracting archive using a data processing computer, said method comprising the steps of:
(a) providing an input data file; and
(b) reducing the size of the self-extracting archive by including in the archive only the code needed by the algorithms actually used in creating the self-extracting archive.

8. The method of claim 7, further including the step of:
(c) determining if the size overhead required for the decompression of a particular algorithm in a self-extracting archive results in an overall size savings by comparing it against the size of the data with and without a particular compressor.

9. The method of claim 8, further including the steps of:
(c-1) compressing inverse algorithms; and
(d) providing a compact inverse algorithm and loader as the uncompressed executable portion of the self-extracting archive.

10. The method of claim 9, further including the step of combining in a single executable file a small uncompressed loader and decompressor adapted for use in the first stage of a decompression process; a simple archive that includes user interface code, as well as a number of dynamically included code segments for each of the algorithms shown to be efficient and necessary to decompress the optimized archive file/payload, the file/payload comprising a normal file data.

11. The method of claim 10, wherein the file/payload comprises a file having a STUFFIT®, ZIP®, RAR® or similar archive file format.

12. The method of claim 8, further including the step of combining in a single executable file a small uncompressed loader and decompressor adapted for use in the first stage of a decompression process; a simple archive that includes user interface code, as well as a number of dynamically included code segments for each of the algorithms shown to be efficient and necessary to decompress the optimized archive file/payload, the file/payload comprising a normal file data.

13. The method of claim 12, wherein the file/payload comprises a file having a STUFFIT®, ZIP®, RAR® or similar archive file format.

14. The method of claim 7, further including the step of combining in a single executable file a small uncompressed loader and decompressor adapted for use in the first stage of a decompression process; a simple archive that includes user interface code, as well as a number of dynamically included code segments for each of the algorithms shown to be efficient and necessary to decompress the optimized archive file/payload, the file/payload comprising a normal file data.

15. The method of claim 14, wherein the file/payload comprises a file having a STUFFIT®, ZIP®, RAR® or similar archive file format.
